(19) United States
(12) Patent Application Publication
(10) Pub. No.: US 2007/0200869 A1
(43) Pub. Date: Aug. 30, 2007

(54) Process for linking arbitrary computer models for process optimization

(76) Inventors: Darrell Dan Massie, Fort Montgomery, NY (US); John Mitchell Hill, West Point, NY (US); Peter Scott Curtiss, Boulder, CO (US); Michael Alan Miller, Shreveport, LA (US)

Correspondence Address: Darrell D. Massie;Attn: MADN-CME, 646 Swift Road, West Point, NY, 10996-1905, US

(21) Appl. No.: 10/980,631

(22) Filed: Nov. 3, 2004

(51) Int. Cl. G09G 5/00

(52) U.S. Cl. 345/619

(57) ABSTRACT

A process for providing a method for describing the sequencing of computer-based process models comprising the steps of: sequencing the models in the correct order, ascribing inputs to models based on outputs of precedent models, and allowing the inclusion of arbitrary control variables that are not derived from model outputs.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract # W911SD-04-P-0299 awarded by DOD.

### CROSS REFERENCE TO RELATED APPLICATIONS

The proposed invention is similar to U.S. Pat. No. 6,763,324 (Integrated engineering analysis process with solution feedback) in that the system determines at least one final output value in response to at least one initial input value. However, U.S. Pat. No. 6,763,324 is used specifically for aircraft engine design and is based on a static chaining of models. This is significantly different from the present invention where the sequencing of models is reconfigurable.

The proposed invention is also similar to U.S. Pat. No. 6,738,753 (Modular, hierarchically organized artificial intelligence entity) in the sense of using hierarchical models. However, that patent is geared towards the use of intelligent learning entities that attempt to develop an artificial intelligence using multiple similar models, not the chaining of widely disparate types of models as demonstrated in the present invention.

### DESCRIPTION OF ATTACHED APPENDIX

Not Applicable

### BACKGROUND OF THE INVENTION

This invention relates generally to the field of process measurement and control and more specifically to a process for linking arbitrary computer-based component models for use in process optimization. Within the past three decades, huge advancements have been made in the fields of computer-oriented measurement, modeling, and control. The ability to develop dynamic models and on-line computational components is highly advanced. However, using these models to represent process sequences and cascaded effects requires special codes and often manual transport of the data.

When using the computer models to optimize the performance of systems it is necessary to run different scenarios to determine the effects of changing current process inputs on the future process outputs. In most cases, it is necessary to run many difference scenarios, possibly thousands or millions, depending on the sophistication of the process. Consequently, any manual data manipulation in a sequence of models is restrictive to the point of disallowing optimization calculations to occur in a timely fashion.

Within this framework, therefore, the present invention has been developed as way to link computer models in an efficient way to facilitate the use of optimization algorithms. The architecture of the described invention consists of xml schemas and an overall framework that, once configured, takes advantage of running models and component-based transactions to sequence models in an organized and consisted manner.

### BRIEF SUMMARY OF THE INVENTION

The primary object of the invention is to provide a method for describing the sequencing of computer-based process models.

Another object of the invention is to structure the mapping of the process models to assign the input parameters of successive models to the output values of models that have already run.

Another object of the invention is to facilitate execution of the process models so that potential time-variable profiles for the controlled process variables can be easily and quickly investigated.

Yet another object of the invention is to allow the use of easy-to-understand alphanumeric descriptions of models.

Still yet another object of the invention is to provide easy interfacing with other components through the use of COM development.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for describing the sequence of computer-based process models comprising the steps of: structuring the mapping of the models so that model inputs and outputs are calculated in the prescribed order to accommodate downstream models that rely on the output of precedent models, allowing the inclusion of control variables as model inputs, and storing the resulting map in an easy-to-interpret xml schema.

The invention, hereafter referred to as the model map, is reliant on a stand-alone dynamic link library that runs in the Microsoft Windows environment.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart showing potential use of a model map

FIG. 2 is an example representation of what a model map would look like stored in xml format.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The figures are all schematic representations of the different portions of this invention. Preferred embodiments of the present invention are now described with reference to the accompanying drawings.

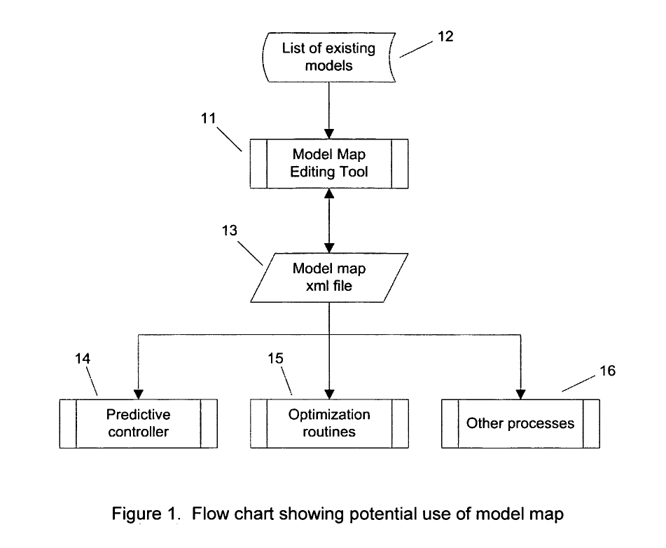

With reference to FIG. 1, the flow chart showing potential use of model maps is depicted. The description of sequencing of model inputs and outputs is facilitated by an editing tool 11 that collects all salient input/output information from a list of existing models 12. The creation of this list depends on other tools. The model map editing tool 11 allows for textual or graphical connection of models and can persist the description in a configuration file 13. Once created, this configuration file can be used by any other applications that may need to use a particular chained sequence of computer models such as a predictive controller 14, a process optimization module 15, or any other application 16.

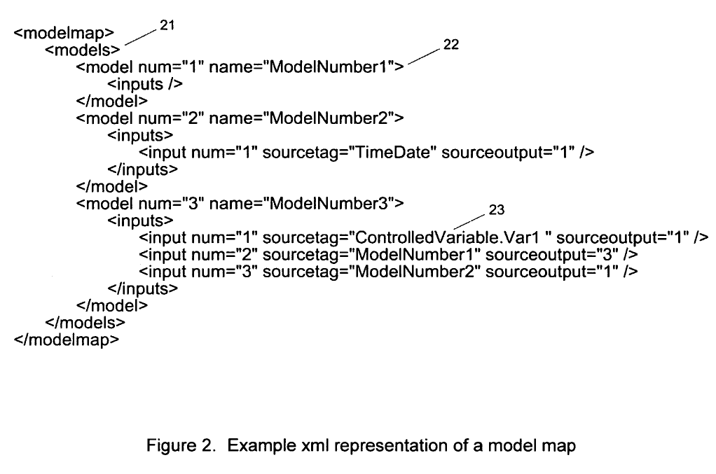

With reference to FIG. 2, an example of xml format for model map storage is shown. The model map xml file uses one child node 21 off the root node. All sequenced models are contained in this child node. The structure of each model description node 22 is that models are presented in the order they are to be executed, and outputs from models are referenced in subsequent models using the sourcetag attribute 23. Any number of inputs can be assigned to a specific model, although correspondence to the actual number of model inputs is, of course, preferred. The sourceoutput attribute is used to denote which output to use from precedent models that have more than one output. If a sourcetag attribute value does not correspond to the name of a precedent model then it is assumed to refer to a controlled variable, i.e., one that will be modified as an external input to the model maps.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for providing a method for describing the sequencing of computer-based process models comprising the steps of:
sequencing the models in the correct order;
ascribing inputs to models based on outputs of precedent models; and
allowing the inclusion of arbitrary control variables that are not derived from model outputs
